(19) United States
(12) Patent Application Publication
(10) Pub. No.: US 2011/0029482 A1
(43) Pub. Date: Feb. 3, 2011

(54) SYNCHRONIZING A CHANGE OF A MODULAR DOCUMENT

(76) Inventors: Roger Brian Gimson, Bristol (GB); Robert Thomas Owen Rees, Newport (GB); Helen Balinsky, Cardiff Wales (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/511,500

(22) Filed: Jul. 29, 2009

(51) Int. Cl. G06F 17/30; G06F 15/16

(52) U.S. Cl. 707/624; 709/204; 707/E17.005

(57) ABSTRACT

A first electronic device stores a modular document composed of plural component documents that are combined to allow presentation of the modular document. A surrogate of the modular document is sent to a second electronic device. A change of the surrogate made at the second electronic device is synchronized with the modular document, or a change of the modular document is synchronized with the surrogate at the second electronic device.

### BACKGROUND

It is common to share documents between users to allow for review of, or remote collaboration in creation of, the documents. A document may be a word processor document that is initially authored by a first user. The first user may then provide a copy of the document to a second user for the second user to review and possibly modify. This review and modification process may involve one or more additional users.

The changed document can then be sent back to the first user, who can then review the modified document and attempt to manually enter modifications reflected in the changed document into the original document, or alternatively, the first user can replace the original document with the changed document. Such a process of manually modifying the original document to incorporate modifications reflected in the changed document is a tedious process that can sometimes result in errors when the first user misses some modifications or forgets to replace the original document with the changed document.

### BRIEF DESCRIPTION OF THE DRAWINGS

Some embodiments of the invention are described with respect to the following figures:

FIG. 1 is a block diagram of an exemplary arrangement that includes multiple computers, in which an embodiment of the invention can be incorporated;

FIG. 2 is a flow diagram of a process performed by a remote computer for processing a surrogate of a modular document and synchronizing modifications of the surrogate with a master modular document, according to an embodiment;

FIG. 3 is a flow diagram of a process performed by a local computer to send a package containing a modular document to a remote computer and to synchronize modifications of a surrogate of the modular document performed at the remote computer, according to an embodiment;

FIG. 4 is a flow diagram of creating a surrogate of a modular document, according to an embodiment;

FIG. 5 is a flow diagram of a process of performing online packaging of a modular document, according to an embodiment; and

FIG. 6 is flow diagram of a process of performing offline packaging of a modular document, according to an embodiment.

### DETAILED DESCRIPTION

Documents can be in modular form to provide for enhanced flexibility and improved efficiency. A “modular document” refers to a document that is composed of separately identifiable component documents. A “document” refers to a container of data that is identifiable.

The component documents of a modular document are combined to allow for proper presentation (e.g., viewing or listening) of the modular document. Combining of the component documents also achieves a desired behavior of the modular document (e.g., load appropriate objects such as images or text, retrieve variable data from a selected source or sources, etc.). Some component documents can be shared by multiple modular documents, and any one of the component documents of a modular document can be modified or replaced. A modular document generally refers to any data structure container that has references to other documents that in combination make up the modular document.

Under certain scenarios, it may be desirable to share a modular document among multiple users. To enable such sharing, one or more surrogates of the modular document can be provided to one or more users. A “surrogate” refers to a copy of the modular document. The original modular document is referred to as a “master” modular document, while copies of the master modular document are referred to as surrogates.

To provide a surrogate of a modular document to a user, the surrogate can be sent from a local electronic device to a remote electronic device over a network. A “local” electronic device is considered to be the electronic device where the master modular document is located, while a “remote” electronic device is considered to be the electronic device where a surrogate document of the master is located. Note the terms “local” and “remote” are labels used when a particular perspective is assumed—it is possible that, from another perspective, the “local” computer can be considered a “remote” computer holding a surrogate modular document of another master modular document located at yet another electronic device. Sending a surrogate of a modular document involves sending a package containing a copy of the modular document as well as copies of at least some of the component documents of the modular document. In accordance with some embodiments, it is possible for the local electronic device to determine which of the component documents of a modular document are already available at the remote electronic device, and to avoid sending such component documents over a network between the local and remote electronic devices to preserve network bandwidth.

Once surrogates of the master modular document are provided to remote users, it is possible for the remote users to make modifications to the surrogates. Note that after propagation of surrogates, it is also possible for the master modular document at the local electronic device to be modified. The remote users may make modifications to the surrogates at remote electronic devices that are either online or offline with respect to the local electronic device holding the master modular document. A remote electronic device is considered to be online with respect to the local electronic device if the remote electronic device is connected to (or otherwise is able to communicate with) the local electronic device. On the other hand, the remote electronic device is considered to be offline with respect to the local electronic device if the remote electronic device is disconnected from (or otherwise unable to communicate with) the local electronic device.

In any case, it is desirable that modifications made to any of the surrogates and/or to the master modular document are automatically synchronized with each other. If a remote electronic device is online with respect to the local electronic device, then the synchronization can occur in real time. On the other hand, if the remote electronic device is offline with respect to the local electronic device, then the modifications of the surrogate can be synchronized to the master modular document (or modifications of the master modular document can be synchronized to the surrogate) the next time the remote electronic device becomes online with respect to the local electronic device.

Automatic synchronization of changes to surrogates and/or of changes to the master allows for accurate and efficient propagation of surrogate and/or master changes. By not having to rely on manual action of a user to propagate changes to the document(s), mistakes in synchronization can be avoided or reduced.

Another benefit offered by some embodiments is that modification of a modular document can be performed at a remote electronic device even if the remote electronic device is offline with respect to a local electronic device in which the master modular document is located. As noted above, offline modification of a modular document is enabled by providing a surrogate of the modular document to the remote user. The remote user can then perform viewing and/or modification of the surrogate, and any modifications made to the surrogate can automatically be synchronized with respect to the master modular document the next time the remote user regains connectivity with the master modular document. Similarly, any modification of the master modular document at the local computer can be propagated to the remote computer the next time the remote computer regains connectivity with the master modular document.

Examples of local and remote electronic devices include one or more of the following: desktop computers, notebook computers, server computers, personal digital assistants (PDAs), smart phones, gaming consoles, music/video players, or other types of electronic devices. One example of a modular document includes a word processing document that contains two or more of the following component documents: a template, image document, text document, and so forth. Another example of a modular document is a web page that has two or more of the following component documents: HTML (Hypertext Markup Language) document, image document, script, style sheet, and so forth.

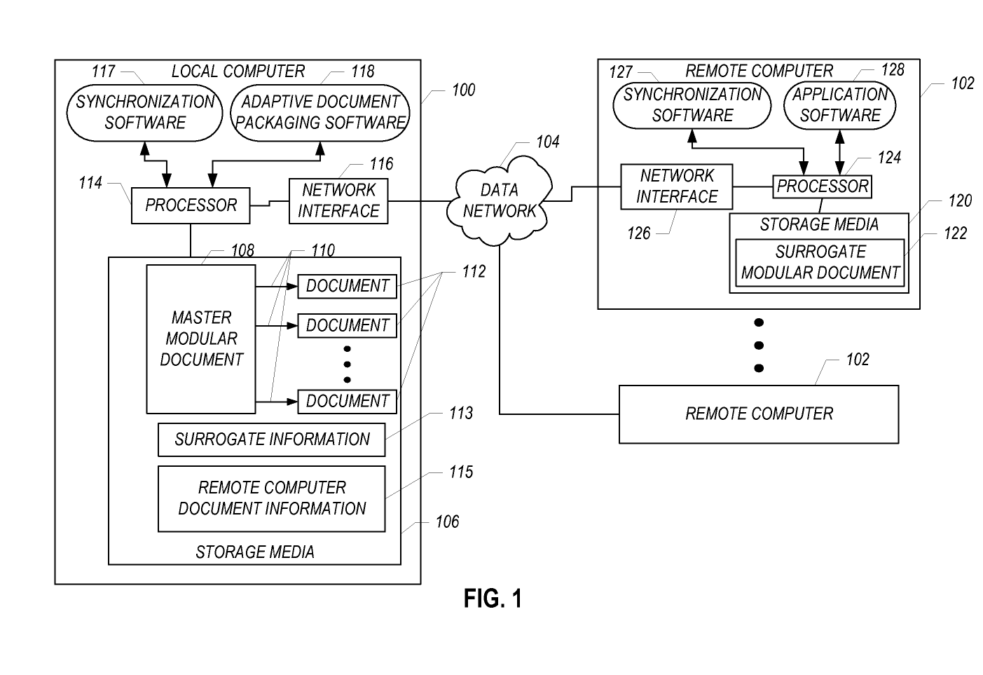

FIG. 1 is a block diagram of an exemplary arrangement that includes a local computer 100 (or other local electronic device) and one or more remote computers 102 (or other remote electronic devices) that are coupled over a data network 104 to the local computer 100. Examples of the data network 104 include a local area network (LAN), a wide area network (WAN), the Internet, and so forth.

The local computer 100 includes storage media 106, which can be implemented with one or more disk-based storage devices and/or one or more integrated circuit (IC) or semiconductor memory devices. As shown in the example in FIG. 1, the storage media 106 contains a modular document 108 (referred to as a “master” modular document in the example of FIG. 1) that references 110 multiple component documents 112. Although just one modular document 108 is shown, it is noted that the storage media 106 can contain more than one modular document. It is also noted that in some applications, at least one of the component documents 112 can itself be a modular document that references other component documents. Thus, generally, a first modular document can reference component documents, where it is possible that at least one of the component documents is a second modular document that in turn references additional component documents. Moreover, it is also possible that at least one of the additional component documents is a third modular document that references further component documents. This hierarchical referencing of modular documents can be performed to any depth.

The storage media 106 further stores surrogate information 113 that stores information identifying surrogates of the master modular document 108. The surrogate information 113 can identify remote locations where surrogates are stored. The surrogate information 113 allows the local computer 100 to inform all surrogates of changes made to the master modular document or to other surrogates. In an alternative embodiment, instead of using the surrogate information 113 kept at the local computer 100, a remote computer that holds a surrogate modular document can instead perform polling to determine what changes should be made to the surrogate modular document. This polling can be performed in response to an event, such as one or more of when the remote computer goes online, when the surrogate modular document is opened for presentation, at fixed intervals, and so forth.

In addition, the storage media 106 also stores remote computer document information 115, which contains information identifying documents that are stored at a particular one of the remote computers 102. For example, the remote computer document information 115 can indicate which component documents are available at the particular remote computer 102. The remote computer document information 115 can be used to determine which component documents of the master modular document 108 are to be sent to the particular remote computer 102 when sending a surrogate of the mater modular document 108 to the particular remote computer 102.

The local computer 100 further includes a processor 114 connected to the storage media 106. The processor 114 is connected to a network interface 116 that allows the local computer 100 to communicate over the data network 104 with the remote computers 102.

In addition, the local computer 100 includes synchronization software 117 that is executable on the processor 114 and manages the synchronization of the master modular document 108 with respect to one or more surrogates of the master modular document 108 maintained at one or more remote computers 102.

Moreover, the local computer 100 includes an adaptive document packaging software 118 that is executable on the processor 114. The adaptive document packaging software 118 is able to perform adaptive packaging of component documents of a modular document that is to be transmitted from the local computer 100 to the remote computer 102, where “adaptive packaging” refers to the process of identifying a subset of the component documents that are not already available at the remote computer 102. The adaptive document packaging software 118 can access the remote computer document information 115 to determine which component documents are already available at the remote computer 102.

As further shown in FIG. 1, a remote computer 102 includes storage media 120 that contains a surrogate modular document 122, which is a copy of the master modular document 108. Although not shown, the surrogate modular document 122 includes references to component documents 112, which may themselves have surrogates on the remote computer 102.

The storage media 120 in the remote computer 102 is connected to a processor 124, which is connected to a network interface 126 to allow the remote computer 102 to communicate over the data network 104.

The remote computer 102 also includes synchronization software 127 and application software 128 that are executable on the processor 124. The synchronization software 127 cooperates with the synchronization software 117 in the local computer 100 to automatically synchronize any modifications to the surrogate modular document 122 with the master modular document 108 in the local computer 100 (and vice versa). The application software 128 can be a word processing software, a web browser, and so forth.

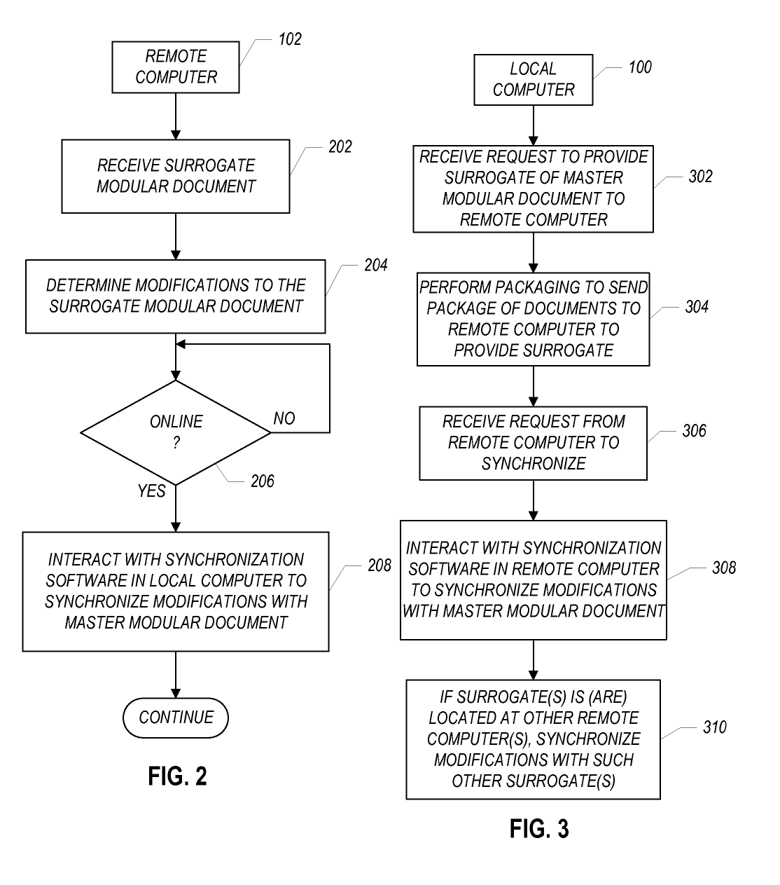

FIG. 2 is a flow diagram of a process performed by a remote computer 102, in accordance with an embodiment. The remote computer 102 receives (at 202) a surrogate modular document. As discussed above, the receipt of a surrogate modular document involves receiving a package that includes the primary document that references component documents, where the package can include just a subset of the component documents or all of the component documents, depending upon the circumstance (discussed further below). Once the surrogate modular document is received, the remote computer 102 stores the surrogate modular document, and allows a user at the remote computer 102 to view the surrogate modular document and to perform modifications to the surrogate modular document.

The synchronization software 127 in the remote computer 102 detects (at 204) modifications to the surrogate modular document. Upon detection of such modifications, the synchronization software 127 determines (at 206) whether the remote computer 102 is online with respect to the local computer 100. If not, the synchronization software 127 waits until the remote computer 102 becomes online with respect to the local computer 100. Once the remote computer 102 is online with respect to the local computer 100, the synchronization software 127 in the remote computer 102 is able to interact (at 208) with the synchronization software 117 in the local computer 100 to synchronize modifications made to the surrogate modular document with the master modular document.

It is noted that modifications may have been made at the master modular document rather than at the surrogate modular document. In this alternative case, the synchronization software 127 in the remote computer 102 interacts with the synchronization software 117 in the local computer 100 to synchronize modifications made to the master modular document with the surrogate modular document.

FIG. 3 is a flow diagram of a process performed at the local computer 100 according to an embodiment. The local computer 100 receives (at 302) a request to provide a surrogate of the master modular document to a remote computer 102. This request may be submitted by a user through a user interface, such as a graphical user interface (GUI) that allows a user to select one or more remote computers to which one or more surrogates of the master modular document are to be sent. Alternatively, the request can be submitted by application software executing in the local computer 100 or in the remote computer 102.

In response to the received request to provide a surrogate of the master modular document, the local computer 100 performs (at 304) packaging to send a package of documents to the remote computer to provide the surrogate to the remote computer. The packaging can be adaptive document packaging performed by the adaptive document packaging software 118 in the local computer 100. The packaging is performed differently depending upon whether the local computer 100 is online with respect to the remote computer 102, or offline with respect to the remote computer 102. The different packaging techniques depending upon whether the remote computer 102 is online or offline is discussed further below with respect to FIGS. 5 and 6.

Subsequently, after the package of documents has been sent to the remote computer 102 to allow a surrogate of the master modular document to be provided at the remote computer, the synchronization software 117 in the local computer 100 receives (at 306) a request from the remote computer 102 to synchronize modifications to the surrogate modular document with the master modular document 108. In response to such requests, the synchronization software 117 in the local computer 100 interacts (at 308) with the synchronization software 127 in the remote computer 102 to synchronize modifications to the surrogate modular document 122 with the master modular document 108. In addition, if other surrogate(s) is (are) located at other remote computer(s), then the synchronization software 117 in the local computer 100 interacts (at 310) with synchronization software at the other remote computer(s) to propagate the modifications to the other surrogate modular document(s).

In another scenario, modifications may have been made at the master modular document 108 in the local computer 100 rather than at a surrogate. In this case, the synchronization software 117 will propagate the changes made to the master modular document 108 to one or more surrogates of the master modular document 108.

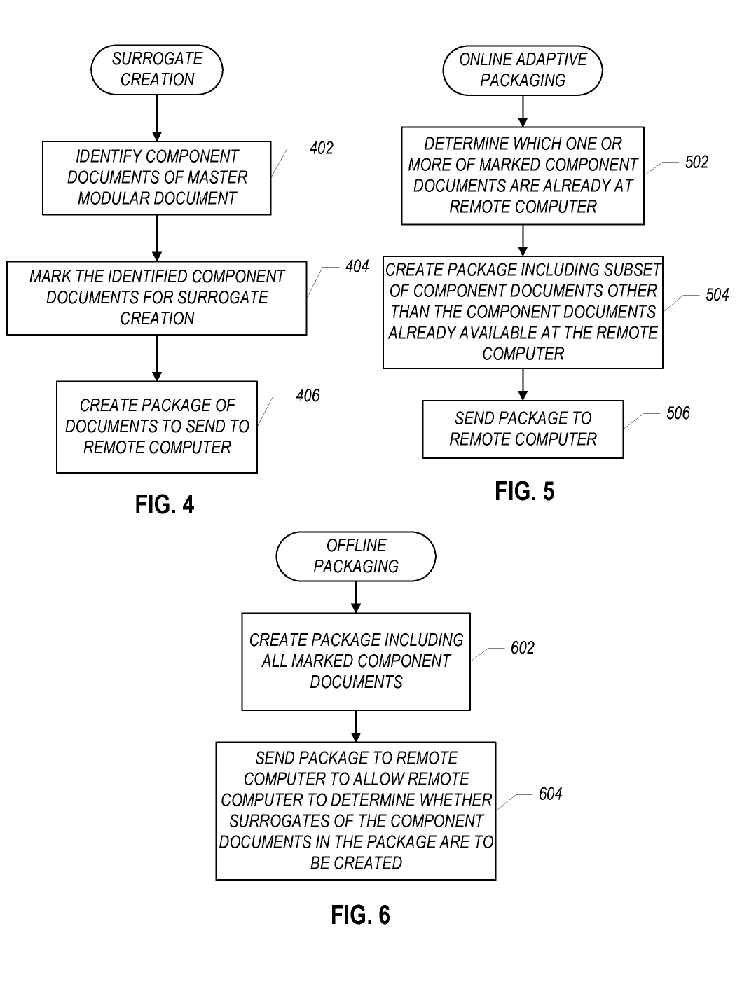

FIG. 4 is a flow diagram of a process of performing surrogate creation, according to an embodiment. In response to receiving a request to provide a surrogate of the master modular document 108, the component documents of the master modular document 108 are identified (at 402). The component documents of the master modular document 108 are all documents that are referenced by the master modular document 108—stated differently, the component documents are the documents for which dependency references are contained in the master modular document 108.

Note that it is also possible that one or more of the component documents referred to by the master modular document 108 can also be modular documents; in this scenario, the additional component documents of such one or more modular documents referenced by the master modular document 108 are identified (at 402). It is possible that there can be multiple levels of referencing to modular documents to an arbitrary depth; in accordance with some embodiments, all component documents within the hierarchy are identified (at 402).

The identified component documents are marked (at 404) for surrogate creation. Thus, not only is a copy of the master modular document 108 provided to a remote computer 102, but all component documents referenced (directly or indirectly) by the master modular document 108 also have to be copied to the remote computer 102 to enable proper creation of the surrogate modular document at the remote computer 102.

Next, a package of the documents to be sent to the remote computer 102 is created (at 406). The packaging performed at 406 differs depending upon whether the remote computer 102 is online with respect to the local computer 100, or offline with respect to the local computer 100.

FIG. 5 shows online adaptive packaging (when the remote computer 102 is online with respect to the local computer 100). With online adaptive packaging, the adaptive document packaging software 118 determines (at 502) which one or more of marked component documents are already at the remote computer 102 (such as based on the remote computer document information 115 stored at the local computer 100 in FIG. 1 or by directly communicating with the remote computer 102). The adaptive document packaging software 118 then creates (at 504) a package including a subset of component documents other than the component documents that are already available at the remote computer 102. The package is then sent (at 506) to the remote computer 102. In this case, the remote computer 102 is able to generate the surrogate modular document 122 using the subset of component documents contained in the package as well as other component documents that are locally available at the remote computer 102.

FIG. 6 shows offline packaging (performed when the remote computer 102 is offline with respect to the local computer 100). With offline packaging, the adaptive document packaging software 118 creates (at 602) a package that includes all marked component documents (marked at 404 in FIG. 4). The package including all marked component documents is then sent (at 604) to the remote computer 102. Since the remote computer 102 is offline in this scenario, the sending of the package from the local computer 100 to the remote computer 102 can be performed using a removal storage medium, electronic mail, or other communication mechanism that relies on intermediate storage of the package.

Because all marked component documents of the modular document are included in the package, the remote computer 102 determines whether surrogates of one or more of the component documents in the package are to be created. Certain ones of the component documents in the received package may already be locally available at the remote computer 102—copies of the locally available component documents do not have to be made.

Generally, the foregoing has described a technique or mechanism in which a local computer contains a modular document (assumed not to be a surrogate) that is to be copied to remote computer(s) as surrogate(s). The modular document at the local computer is made the master (if it is not already). If a surrogate for the master modular document already exists on the remote computer, a new surrogate does not have to be created. This same approach is applied recursively to all dependent component documents on the local computer.

Alternatively, the document to be copied (either the modular document or one of its component documents) may already be a surrogate associated with a master on another computer. If the document is known to already exist at the remote computer (either as a mater or surrogate), then the document does not have to be sent to the remote computer. However, if the document does not already exist at the remote computer, then a surrogate is created that is associated with the original master (not the surrogate at the local computer).

Instructions of software described above (including synchronization software 117, adaptive document packaging software 118, synchronization software 127, or application software 128 of FIG. 1) are loaded for execution on a processor (such as processor 114 or 126 in FIG. 1). The processor includes microprocessors, microcontrollers, processor modules or subsystems (including one or more microprocessors or microcontrollers), or other control or computing devices. As used here, a “processor” can refer to a single component or to plural components (e.g., one or more CPUs in one or more computers).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
storing, at a second electronic device, a surrogate of a modular document that is located at a first electronic device, wherein the modular document is composed of plural component documents that are combined to allow presentation of the modular document;
modifying the surrogate at the second electronic device; and
automatically synchronizing a change of the surrogate with the modular document.

2. The method of claim 1, further comprising:
automatically synchronizing a change of the modular document that is located at the first electronic device with the surrogate at the second electronic device.

3. The method of claim 2, wherein the modular document is changed at the first electronic device while the second electronic device is offline with respect to the first electronic device,
wherein synchronizing the change of the modular document with the surrogate is performed when the second electronic device subsequently establishes communication with the first electronic device.

4. The method of claim 2, wherein the modular document is changed at the first electronic device while the second electronic device is online with respect to the first electronic device.

5. The method of claim 1, wherein modifying the surrogate at the second electronic device comprises modifying the surrogate while the second electronic device is offline with respect to the first electronic device,
wherein the synchronizing is performed when the second electronic device subsequently establishes communication with the first electronic device.

6. The method of claim 1, wherein modifying the surrogate at the second electronic device comprises modifying the surrogate while the second electronic device is online with respect to the first electronic device.

7. The method of claim 1, further comprising:
receiving, at the second electronic device, copies of at least some of the plural component documents from the first electronic device.

8. The method of claim 7, wherein receiving the copies of the at least some of the plural component documents comprises receiving the copies of the at least some of the plural component documents determined by the first electronic device to be not already available at the second electronic device.

9. The method of claim 1, further comprising:
receiving, at the second electronic device, copies of the plural component documents from the first electronic device; and
determining, at the second electronic device, which of the plural component documents are already available at the second electronic device.

10. The method of claim 1, further comprising:
sending a copy of the surrogate from the second electronic device to a third electronic device, wherein the copy sent to the third electronic device is associated with the modular document at the first electronic device.

11. A first electronic device comprising:
a storage media to store a modular document composed of plural component documents that are combined to allow presentation of the modular document; and
a processor to:
send a surrogate of the modular document to a second electronic device; and
synchronize a change of the surrogate made at the second electronic device with the stored modular document, or synchronize a change of the stored modular document with the surrogate at the second electronic device.

12. The first electronic device of claim 11, wherein the plural component documents are combined to determine a behavior of the document.

13. The first electronic device of claim 11, wherein the processor is configured to further:
determine one or more of the plural component documents that are already available at the second electronic device,
wherein the surrogate is sent to the second electronic device by sending a subset of the plural component documents other than the one or more component documents already available at the second electronic device.

14. The first electronic device of claim 13, wherein the processor is configured to further include the modular document and the subset of the plural component documents in a package.

15. The first electronic device of claim 14, wherein the processor is configured to further send the package to the second electronic device.

16. The first electronic device of claim 11, wherein the processor is configured to further:
determine whether the second electronic device is online with respect to the first electronic device;
if the second electronic device is online with respect to the first electronic device, create a package including the modular document and a subset of the plural component documents to send to the second electronic device, wherein the subset of the plural component documents does not include one or more of the plural documents that are already available at the second electronic device; and
if the second electronic device is offline with respect to the first electronic device, create a package including the modular document and all of the plural component documents to send to the second electronic device.

17. The first electronic device of claim 11, further comprising synchronization software executable on the processor to synchronize the stored modular document with the change of the surrogate made at the second electronic device, or to synchronize the change of the stored modular document with the surrogate at the second electronic device.

18. The first electronic device of claim 17, wherein the synchronization software is executable to interact with synchronization software in the second electronic device to perform the synchronizing.

19. An article comprising at least one computer-readable storage medium containing instructions that upon execution by a processor causes a first electronic device to:
create a package containing a modular document and at least some of plural component documents that the modular document is composed of;
send the package to a second electronic device to cause a surrogate of the modular document to be created at the second electronic device; and
synchronize the modular document at the first electronic device with the surrogate at the second electronic device to reflect either a change at the modular document or a change at the surrogate.

20. The article of claim 19, wherein creating the package comprises including component documents based on whether the second electronic device is online or offline with respect to the first electronic device.
